(19) United States
(12) Patent Application Publication
(10) Pub. No.: US 2017/0043717 A1
(43) Pub. Date: Feb. 16, 2017

(54) System and Apparatus that Alert Car Drivers Approaching Obstacles in the Road

(71) Applicant: Arie Heiman, Sde Warburg (IL)

(72) Inventor: Arie Heiman, Sde Warburg (IL)

(21) Appl. No.: 15/230,498

(22) Filed: Aug. 8, 2016

Related U.S. Application Data
(60) Provisional application No. 62/202,926, filed on Aug. 10, 2015.

(51) Int. Cl. B60Q 9/00; G08G 1/017

(52) U.S. Cl. CPC B60Q 9/008; G08G 1/0175

(57) ABSTRACT

A method for obstacle detection, the method includes receiving, by processor, preceding road segment information about a preceding road segment that precedes the vehicle; wherein the preceding road segment information is generated by a first sensor; wherein the processor and the first sensor are either positioned within the vehicle or are mechanically coupled to the vehicle; processing, by the processor, the preceding road segment information to determine whether the vehicle is approaching an obstacle; and when determining that the vehicle is approaching the obstacle then generating, within the vehicle, an obstacle approaching alert.

### CROSS REFERENCE TO RELATED APPLICATIONS

This application claims priority from U.S. provisional patent Ser. No. filing date 62/202,926 filing date Aug. 20, 2015 which is incorporated herein in its entirety.

### BACKGROUND

While driving on the road, a driver can approach obstacles that are not documented well, some are permanent such as bumpers on the road, some are temporary obstacle that just occurred and may last for a short time. Typical obstacle can be car accident, car is parking off road in a way that it is dangerous to the other cars passing by, road is floated by water, snow on the road, road is temporary closed, road is under construction or maintenance, etc. Such obstacles can be dangerous for cars that are approaching the obstacles.

### SUMMARY

There may be provided a method for obstacle detection, the method may include: receiving, by processor, preceding road segment information about a preceding road segment that precedes the vehicle; preceding road segment information may be generated by a first sensor; wherein the processor and the first sensor are either positioned within the vehicle or are mechanically coupled to the vehicle; processing, by the processor, the preceding road segment information to determine whether the vehicle may be approaching an obstacle; and when determining that the vehicle may be approaching the obstacle then generating, within the vehicle, an obstacle approaching alert.

The method may include transmitting another obstacle approaching alert to a computerized system that may be located outside the vehicle.

The first sensor may belong to a mobile computerized device and processor may belong to the mobile computerized device.

The first sensor may be integrated within the vehicle; method may include receiving additional preceding road segment information from a second sensor that may belong to a mobile computerized device.

The first sensor may be a camera.

The preceding road segment information may differ from preceding obstacle location information. It may include preceding obstacle location information and other information sensed by the sensor, it may not include preceding obstacle location information.

The method may include sensing by the first sensor the preceding road segment information.

The sensing and the processing are executed without human intervention.

The method may include receiving potential obstacle passing information that may be sensed by another sensor; and processing, by the processor, the potential obstacle passing information to determine whether the vehicle passed an obstacle; and performing at least one operation out (a) transmitting an obstacle passing alert within the vehicle and (b) transmitting another potential obstacle passing alert to a computerized system that may be located outside the vehicle.

There may be provided a method for obstacle detection, the method may include: receiving, by a processor, potential obstacle passing information that may be sensed by a sensor; processor and the sensor are either positioned within the vehicle or are mechanically coupled to the vehicle; processing, by the processor the potential obstacle passing information to determine whether the vehicle passed an obstacle; and when determining that the vehicle passed the obstacle then performing at least one operation out (a) transmitting an obstacle passing alert within the vehicle and (b) transmitting another potential obstacle passing alert to a computerized system that may be located outside the vehicle.

There may be provided a method for detecting a license plate attached to a vehicle, the method may include: receiving, by processor, license plate identification information about a vehicle registration identifier that appears in the license plate; receiving, from a sensor, an image that may be acquired by the sensor; processor and the sensor are either positioned within the vehicle or are mechanically coupled to the vehicle; searching, by the processor, within the image a license plate that includes the vehicle registration identifier; and when finding within the image the license plate that includes the vehicle registration identifier then transmitting to a computerized system that may be located outside the vehicle information about the finding of the license plate that includes the vehicle registration identifier.

There may be provided an obstacle detection system for detecting an obstacle, the system may include a processor and a first sensor that are either positioned within the vehicle or are mechanically coupled to the vehicle; processor may be configured to receive preceding road segment information about a preceding road segment that precedes the vehicle; preceding road segment information may be generated by the sensor; processor may be configured to process the preceding road segment information to determine whether the vehicle may be approaching an obstacle; and obstacle detection system may be configured to generate, within the vehicle, an obstacle approaching alert when the processor determines that the vehicle may be approaching the obstacle.

There may be provided an obstacle evaluation system, the obstacle evaluation system may include a communication unit and a processor and a storage unit; communication unit may be configured to receive, from multiple vehicles, potential obstacle passing information about potential obstacles that are passed by the multiple vehicle; potential obstacle passing information may be generated by processors based on information sensed by sensors; wherein each processor and each sensor may be either located within any of the multiple vehicles or may be mechanically coupled to any of the multiple vehicles; processor may be configured to evaluate a presence a certain obstacle that may be positioned at a certain location based on at least one of (a) potential obstacle passing information associated with the certain location, and (b) an absence of potential obstacle passing information associated with the certain location; and when the communication unit may be configured to notify the multiple vehicles about the evaluation of the presence of the certain obstacle.

The communication unit may be configured to receive location information about locations of the multiple vehicles and to notify a vehicle of the multiple vehicles about the certain obstacle when it may be evaluated that the certain obstacle may be located at the certain position and when the vehicle may be located within either one of a predefined distance from the certain obstacle or when the vehicle may be within a predefined time period from reaching the certain obstacle.

There may be provided a method for managing obstacle information that method may include receiving from multiple vehicles information about a presence of obstacle at a given location or about an absence of the obstacle at the given location; determining, based on the information whether the obstacle exists in the given location; and updating, based on the determining, the multiple vehicles about the absence or presence of the obstacle at the given location.

The where the determining may include assigning a first weight to information about the presence of the obstacle at the given location; assigning a second weight to information about the absence of the obstacle at the given location; calculating an obstacle variable based on the information provided by the multiple vehicles and to the first and second weights; and determining whether the obstacle exists in the given location based on the obstacle variable.

There may be provided a method for obstacle detection, the method may include: receiving, by a processor, potential obstacle passing information that may be sensed by a sensor; processor and the sensor are either positioned within the vehicle or are mechanically coupled to the vehicle; processing, by the processor the potential obstacle passing information to determine whether the vehicle passed an obstacle; and when determining that the vehicle passed the obstacle then performing at least one operation out (a) transmitting an obstacle passing alert within the vehicle and (b) transmitting another potential obstacle passing alert to a computerized system that may be located outside the vehicle.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a first system that is located, at least partially, within a vehicle and a second system that is located outside the vehicle according to an embodiment of the invention;

FIG. 2 illustrates a device that communicates in a wired or wireless manner with a camera wherein the device and the camera are located, at least partially, within the vehicle according to an embodiment of the invention;

FIG. 3 illustrates a smartphone that is detachably coupled to a front window of a vehicle according to an embodiment of the invention;

FIG. 4 illustrates an image that captured a majority of a warning sign according to an embodiment of the invention;

FIG. 5 illustrates an image that captured another warning sign according to an embodiment of the invention;

FIG. 6 illustrates filtered and un-filtered detection signals from an accelerator that is associated with a vehicle according to an embodiment of the invention;

FIG. 7 illustrates a method according to an embodiment of the invention;

FIG. 8 illustrates a first system that is located, at least partially, within a vehicle and a second system that is located outside the vehicle according to an embodiment of the invention;

FIG. 9 illustrates a first system that is located, at least partially, within a vehicle and a second system that is located outside the vehicle according to an embodiment of the invention;

FIG. 10 illustrates a first system that is located, at least partially, within a vehicle and a second system that is located outside the vehicle according to an embodiment of the invention;

FIG. 11 illustrates a first system and a second system that are located, at least partially, within a vehicle according to an embodiment of the invention;

FIG. 12 illustrates a first system and a second system that are located, at least partially, within a vehicle according to an embodiment of the invention;

FIG. 13 illustrates systems that are located, at least partially, within a pair of vehicles according to an embodiment of the invention;

FIG. 14 illustrates a method according to an embodiment of the invention;

FIG. 15 illustrates a method according to an embodiment of the invention; and

FIG. 16 illustrates a method according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

The term “car” is used as a non-limiting example of a vehicle.

The term “road” is used as a non-limiting example of any path that may be passed by a vehicle.

The term “server” is used as a non-limiting example of a computerized system.

The term “mobile phone” or “smart phone” are non-limiting examples of devices (or systems) that may be, at least temporarily, located within a vehicle.

There may be provided a first system (such as an obstacle detection system) that may be configured to perform at least one of the following: (a) detect an obstacle that is either passed by the vehicle, (b) detect an obstacle that are going to passed by a vehicle, (c) transmit information about such an obstacle to another system, (d) generate within the vehicle an alert about such obstacle. These operations may be executed without human intervention thereby allowing the driver to better concentrate on the driving. The detection of such obstacles may be based upon information sensed by one or more sensors associated with a vehicle and/or by processing the information by a processor that is associated with the vehicle.

The phrase “associated with the vehicle” mean that an element (for example processor or one or more sensor) is located (at least temporarily) within the vehicle during the processing and/or during the sensing of information. The element may be included, for example, within a mobile phone, within an another mobile communication device, may be integrated with the vehicle, and the like.

The processor may be a part of the vehicle, may be included within a vehicle computer, may be included in a mobile system such as smartphone, and the like. The processor is a hardware processor. It may be an image processor, a digital signal processor, an FPGA, a general purpose processor, a hardware accelerator, and the like.

Another system (also referred to as a second system, an obstacle evaluation system, or server) may receive information about an obstacle and may determine whether a real obstacle was passed by the vehicle, whether the vehicle sent information that does not represent a real obstacle, and the like. The obstacle can be first flagged as a potential obstacle and may be regarded as a real obstacle after a verification process.

The other system may be located outside the vehicle or may located with the vehicle. The other system may include one or more computers such as one or more servers that may or may not reside in a cloud computing environment.

The detection of an obstacle that was passed by the vehicle may be sensed by a sensor that is an accelerometer and/or by one or more types of sensors. These types of sensors may include an accelerometer, an image sensor, a radar and the like.

The detection of an obstacle that the vehicle is about to pass may be performed by sensing traffic signs that are positioned between the obstacle and the vehicle.

The detection of an obstacle may be sensed by correlating between information about the obstacle that are obtained before the vehicle reached the obstacle and between information obtained once (or after) the vehicle passed the obstacle.

The first and second system may be integrated and/or may be both associated with the vehicle.

There may be provided one or more systems that can warn automatically the driver in advance, that he is approaching an obstacle. These one or more systems may perform obstacle location detection and analysis of the nature of the obstacle in real time automatically without intervention of the car drivers. These one or more systems may provide an alert to all the car drivers that approaching this obstacle.

Information about the obstacle may be sent to a navigation system like Waze of Google Inc. in order to enable the system to choose a path that bypasses these obstacles when planning the path from point A to point B.

The one or more systems may include one system that may include a computerized device (“device”) such as mobile phone or any other device that is used in the car and a second system that may include one or more computers such as a server which collects from all the cars that pass the obstacle various information. The information is acquired in the car by using various sensors that are embedded in the mobile phone such as Accelerometer, Gyro, Camera, GPS, etc. This data can be processed initially by the mobile phone as will be described later, the outcome of the process can be sent to the server for further processing and the outcome is stored in the server database for further use.

The server will share the obstacle location and its nature with the relevant cars, by either sending to the cars an updated local map or list of all the obstacles and their nature that are near to the cars current location.

The device may identify its location information as an example from its GPS, and combine it with the obstacle location map that was sent by the server, to decide if the car is approaching a known obstacle. If the car approaches a known obstacle, the system will alert the driver in advance that he is approaching an obstacle and its nature. This will allow the driver to prepare himself and slow down before passing the obstacle.

It should be noted that the detection of the obstacles is done automatically without the need of the car driver to report on obstacles. This is important as it enable the driver to concentrate on driving the car and not be distracted from the road by sending reports on obstacles.

The system may also be used to follow after specific car. As an example police provide us the plate number of the suspicious car that was stolen, we can define this car as an obstacle, in this case the server sends to all the cars that are connected to the server the plate number of the specific car. In each car the camera will try to identify the specific car by using image processing algorithm that will analyze the plate number. Once the specific car was identified by one of the cars that are connected to the server, it can be send to the server as an indication that the specific car was identified with its location. The server will be able to forward this info to the relevant authorities.

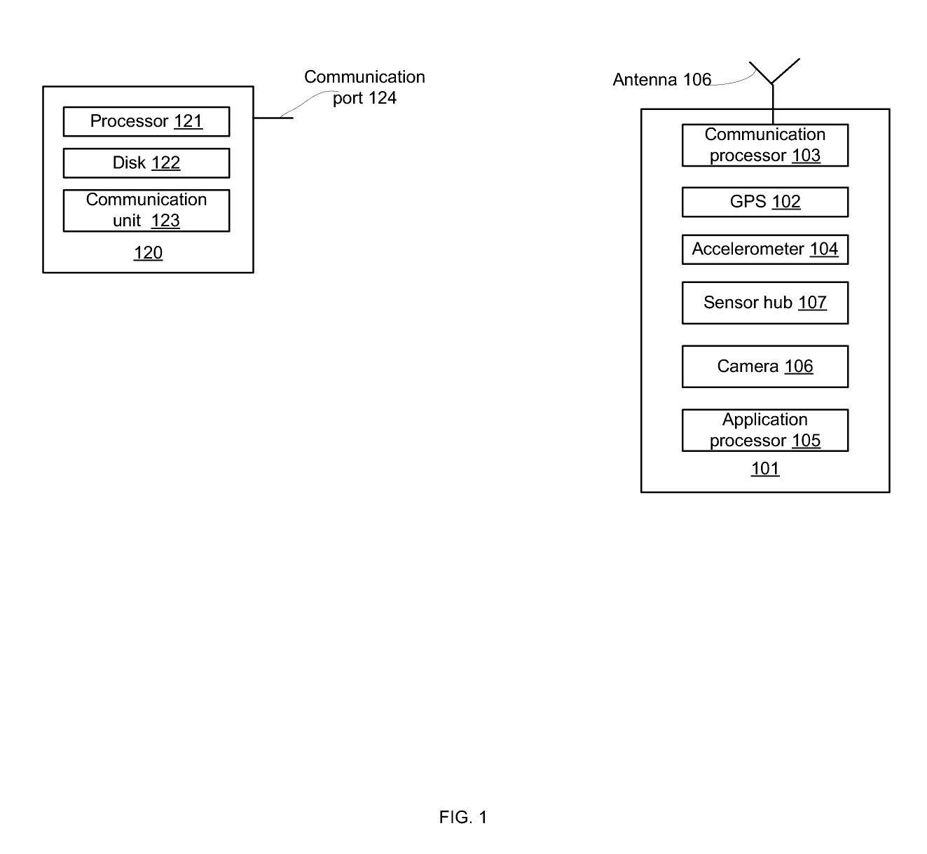

FIG. 1 illustrates a device that is part of a first system (or is the first system), the device may be a mobile phone 101 or any other device that may be used in the car. FIG. 1 also shows a second system such as server 120 that may be arranged to collect from multiple cars that pass the obstacle various information including its location.

The mobile phone 101 may include one or more sensors such as accelerometer 104 or other similar sensors, a location sensor such as global position system (GPS) component 102, camera 106, sensor hub 107 and application processor (AP) 105. Mobile device 101 may also include a communication unit that may include communication processor (CP) 103 and antenna 106 for communicate with the second system (at least one server) and can send or receive relevant digital information from or to the second system.

The mobile phone may be any commercially mobile phone such as but not limited to smartphones manufactured by Apple Inc. of California USA, Samsung Inc. Seoul, South Korea, or any other vendor. Non-limiting example include Galaxy S4, Galaxy S5, Galaxy S6, IPhone 6, a tablet, etc.

The mobile phone 101 may include only some of the components illustrated in FIG. 1, more components than illustrated in FIG. 1 and the like.

The mobile phone may be replaced by one or more standalone devices that may consists only part of these sensors; in this case only partial functionality can be achieved.

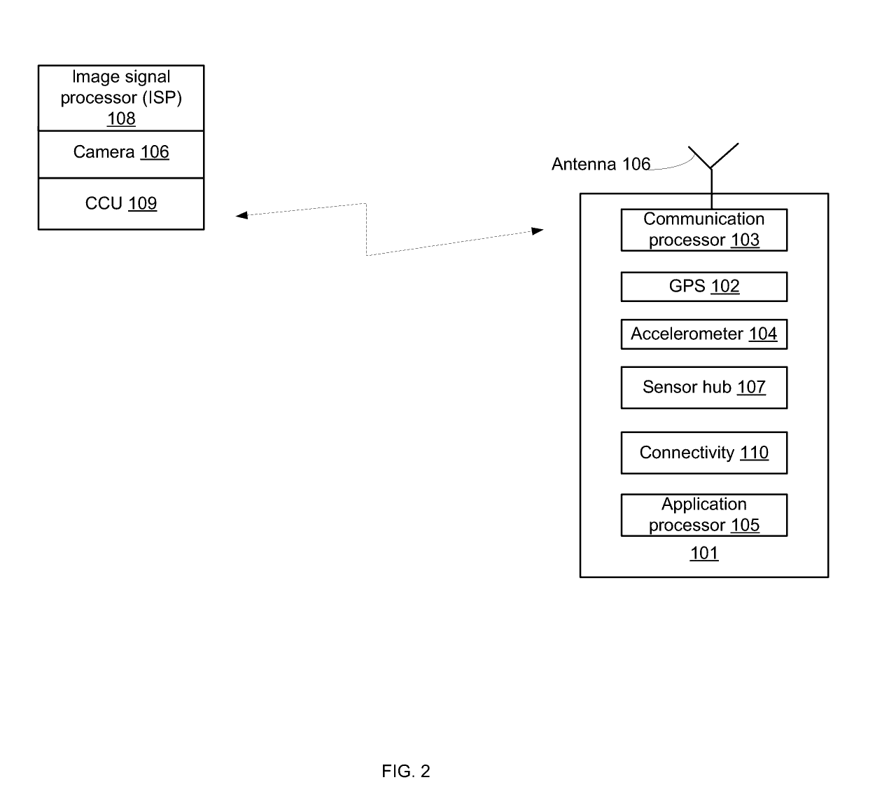

An example of a standalone device can be camera with or without image signal processor that can be connected to mobile phone 101 by wireless or wire connection (see FIG. 2—camera 106 located outside mobile phone 101 and communicates via a camera communication unit (CCU) 109). For simplicity of explanation we refer only to mobile phone however our invention is also relevant to other standalone devices.

Referring to FIG. 1—the application processor 105 runs an application (or any other form of code, instructions and the like) that has at least one of the two functions: (a) alert the car driver that his car is approaching a known obstacle. (b) perform obstacle detection process of known and unknown Obstacles.

The warning process related to obstacles that precede the car may include: the device in the car knows his location that is based on the info from the GPS 102. This location of the car is sent periodically to the server. Based on his location the sever send to the device a list or a local map of obstacles and its nature that are near to his current location. Based on the car location and the list of obstacles, the AP 105 calculates the distance between the nearest obstacle location and the car location. If the distance is below a threshold Th-Distance, the car driver gets an indication (visually or by sound indication or both) that the car approaching an obstacle with its nature. The Th-Distance may be replaced by a time threshold Th-Time. Th-Time depends on the car speed, as the car is driving faster the indication will be earlier in order that the driver will be able to respond to the warning. The car speed can be estimated from sampling the GPS coordination.

In order to analyze the road condition the first system may use various sensors embedded in the mobile phone.

As an example by using the accelerometer the first system can identify that the car pass a bumper, if one use camera that see the road, additional information on the road obstacle can be acquired.

The first system may use the regular sensors of a mobile phone in addition to the camera. Some obstacles are detected by using part or all of the built in sensors without the camera, some obstacles are detected by processing only the camera output and some obstacles are detected by a fusion of the sensors with the camera.

In most of smart phones all the necessary sensors, such as accelerometer, gyro, GPS, and camera are embedded in the phone.

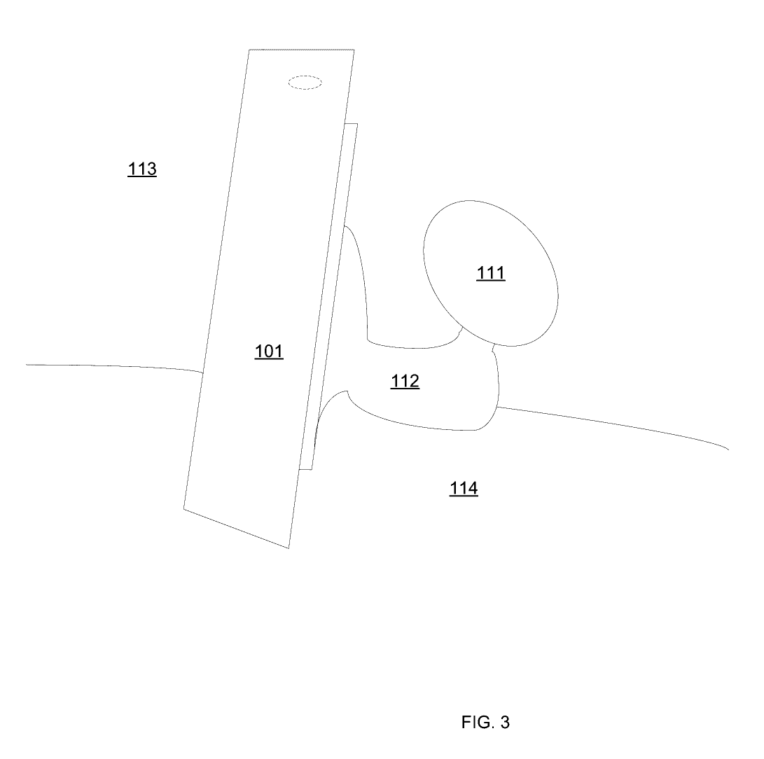

However the use of the camera depends on the location of the smart phone in the car. The camera can be used efficiently if the camera is pointed toward the front of the car to allow the camera viewing the road. (namely the phone is located in the front of the car above the dash board) see FIG. 3 as an example (mobile phone 101 is attached by an interface to the car front window 113 and is positioned above dashboard 114, the interface includes sticker 111 and arm).

In cases where the camera of the mobile phone cannot see the front view of the car, one can use an external camera that faces toward the front view of the car. The connectivity between the camera and the smart phone can be by wire connection such as HDMI or wireless connection such as Wi-Fi or Bluetooth connections (BT).

When images acquired by the camera are available the first system analyses the scene of the road by using image processing algorithms. This analysis is used to detect obstacles. The Image processing can be conducted in the camera ISP 108 (Image Signal Processor), in the mobile phone AP 105 or in the server. It is noted that the camera 106 may or may not include the ISP 108.

Obstacle Detection Process of Known and Unknown Obstacles

To detect an obstacle, the first and/or second system process various sensors output that are embedded in the mobile phone.

Few processes will be described below. Some of the processes may involve analyzing the information provided from each sensor separately combined with GPS information. Some of the process is based on fusion of information from few sensors combined with GPS information.

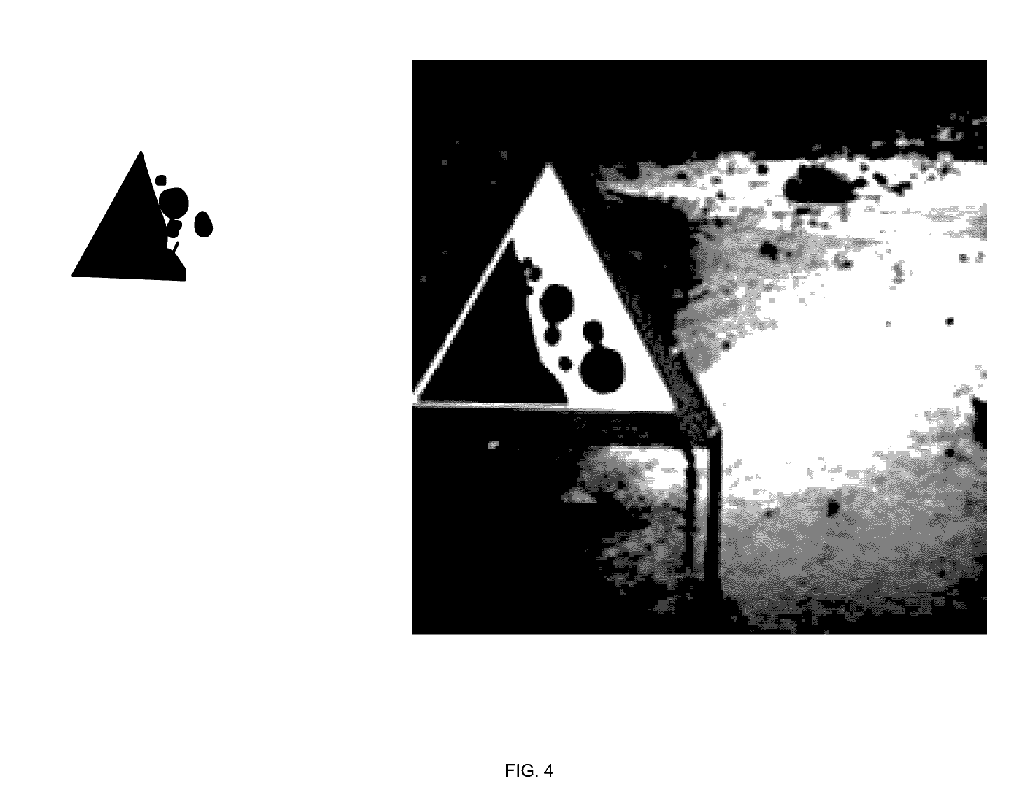

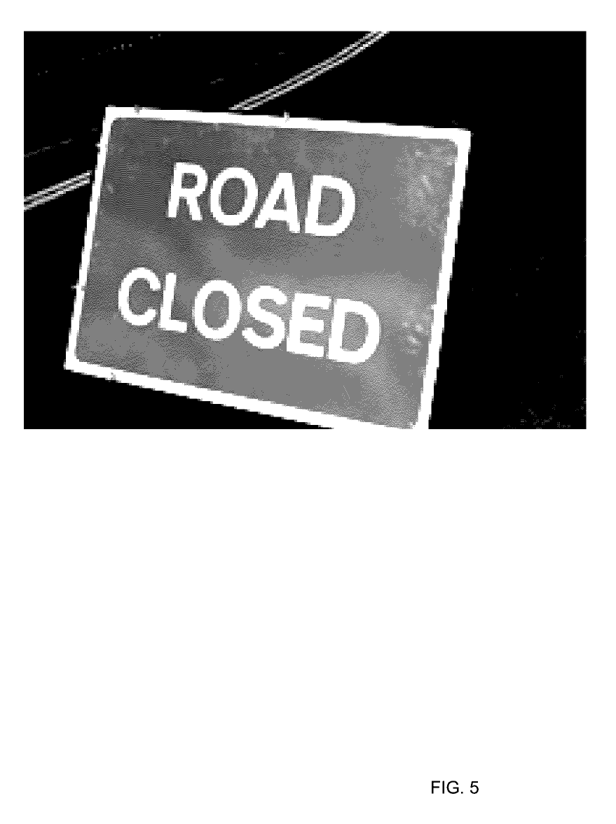

Typical example of the use of one sensor with GPS is the use of camera and GPS for detecting automatically temporary signs on the road, such as “road is closed”, “hazard of falling rocks” etc. See as an example FIG. 4 and FIG. 5.

The output of the camera images can be analyzed by using different scene analysis image processing technology to detect and interpreted those signs. The detection may include image processing (searching for predefined text and/or visual elements that appear in known traffic signals), learning based methods (neural networks) and/or searching for predefined color patterns that appear in traffic signals. Some methods for detecting traffic signs are provided in “An overview of traffic sign detection methods”, Karla Brki´, Department of Electronics, Microelectronics, Computer and Intelligent Systems Faculty of Electrical Engineering and Computing Unska 3, 10000 Zagreb, Croati.

The output of this analysis can be sent to the server for further processing; the server will distribute an alert to all the car drivers that are approaching this location.

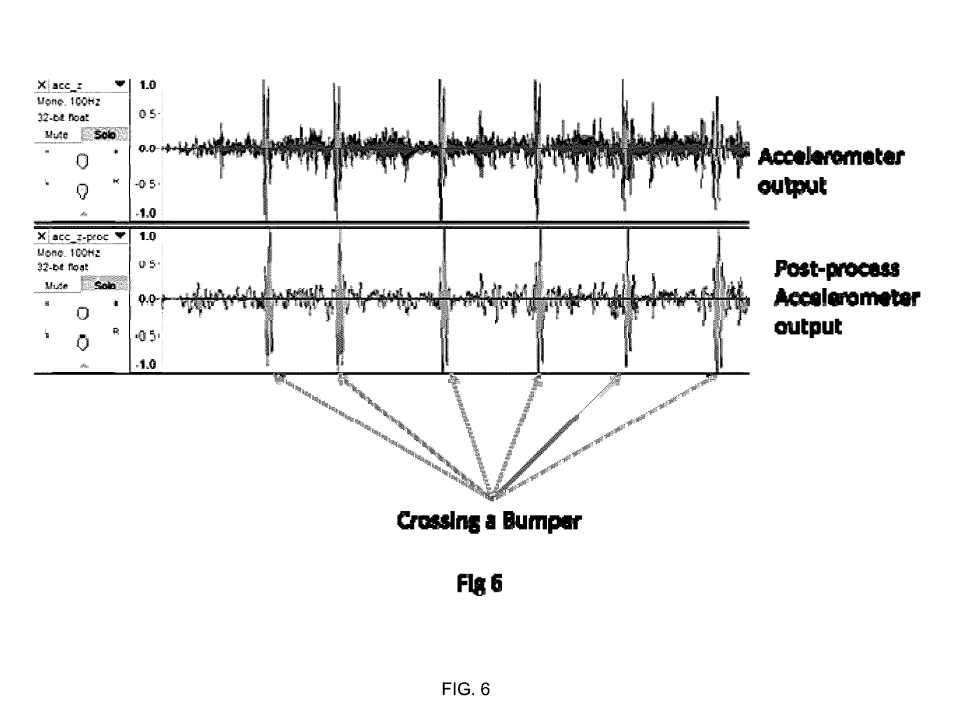

As an example of fusion process, let present a process of detecting a bumper on the road, where the GPS, camera output and the accelerator info are used. Once the car passes a bumper at least one of the accelerometer axis in the mobile phone will sense that he is passing a bumper, typical accelerometer signal will be such as depicted in FIG. 6.

FIG. 6 presents the output of the accelerometer and the filtered one while passing through sequence of bumpers. The picks in the accelerometer signal, provides sufficient data to detect that the car passed a bumper. For more details see the process illustrated in U.S. patent application titled SYSTEM AND METHOD FOR PROVIDING BUMPER ALERTS Ser. No. 15/126930 which is incorporated herein in its entirety. This process works well, however in some cases it can generate false alarm. Namely it might declare an obstacle as bumper where it is not a real bumper. When the first and/or second systems analyze the image of the bumper area that was acquired prior passing the bumper, the first and/or second systems can calculate some basic parameters of the bumper such as width of the obstacle. If the width is bigger than a predefined value we can declare it as a bumper, otherwise it is another obstacle. With the use of the image information it significantly reduces the false alarm.

In order to analyze the bumper by the camera, for each frame of the image the first system attaches a time stamp (for example—the time of acquisition of the image by the camera).

The image and the time stamp are stored in memory unit of the mobile phone 101 (not shown) that may be arranged as a cyclic buffer. Once the bumper is detected by the accelerometer its time stamp is calculated. One or more images that were acquired at a predefined time before that time stamp are fetched and are processed. These one or more images are taken at a time that the car did not reach the bumper—but it is assumed that the bumper was acquired by the camera. That time may be calculated based on the speed of the vehicle and the expected fields of view of the camera. These image is analyzed in order to extract the relevant bumper parameters.

Server Operation

The first system may send to the server information on each obstacle that is passed by the car even if the obstacle is already known. The server may aggregate the information from the various cars that are reporting on the obstacle at the same location, this information is used to increase the reliability of the obstacles.

Referring to the functionality of server 120, in FIG. 1. The server may include an application processor 121 that may execute processes such as the evaluation of an obstacle, updating obstacle databases and the like and sending alerts to vehicles, manage the stored data in Disk 122 and the communication with all the cars using communication units 123 and 124.

The application processor may be configured to serve multiple cars simultaneously.

The server may be configured to perform at least one of the following tasks: (a) receive periodically (or non-periodically) the location of all the car connected to the system and send to each car its relevant obstacle lists that are near to his current car location. (b) From each car passing an obstacle it collects the information that is send by the car to the server and store it for further processing. This information is used for eliminating from the list false obstacles as well as to remove from the list obstacles that are removed from the road.

There may be provided a method that may include receiving from multiple vehicles information about a presence of obstacle at a given location or about an absence of the obstacle at the given location. The information may be provided at different points in time. The information may be obtained when a vehicle of the multiple vehicle passes through the given location.

The receiving of information may be followed by determining, based on the information whether the obstacle exists in the given location; and updating, based on the determining, the multiple vehicles about the absence or presence of the obstacle at the given location. The determining may be executed multiple times (for example—during each one of the multiple point of times—whenever information is receiver).

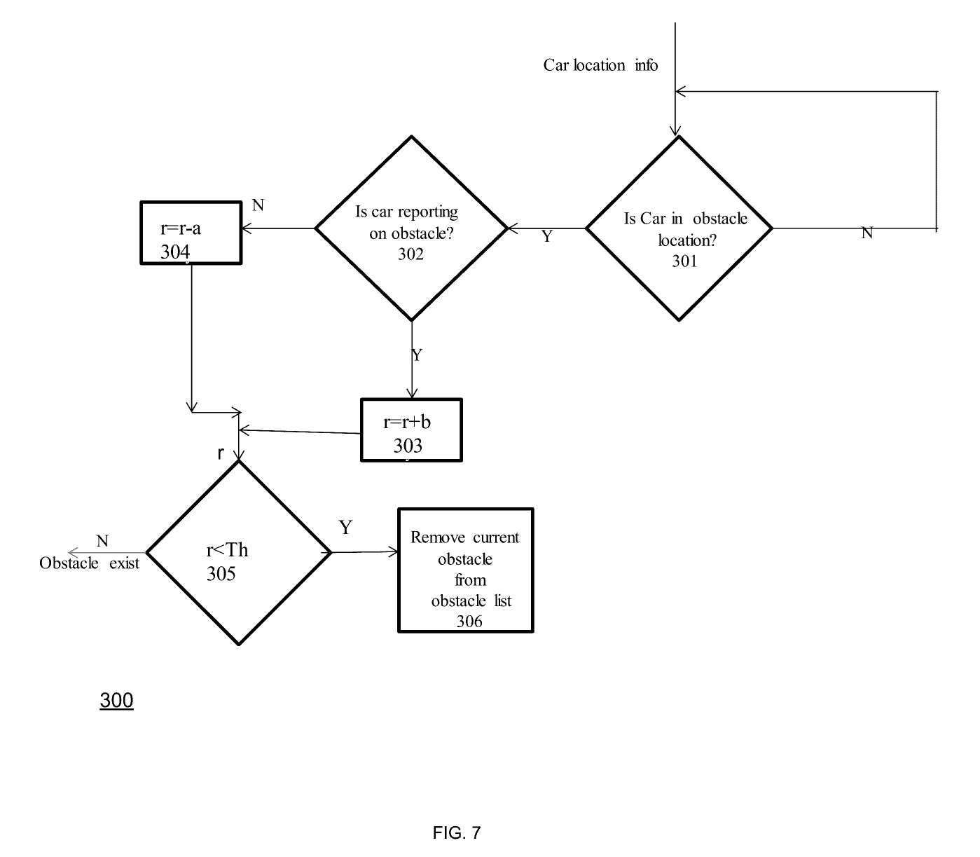

The determining may include assigning a first weight (for example weight a) to information about the presence of the obstacle at the given location, assigning a second weight (for example weight b) to information about the absence of the obstacle at the given location, calculating an obstacle variable (for example r) based on the information provided by the multiple vehicles and to the first and second weights; and determining whether the obstacle exists in the given location based on the obstacle variable. In FIG. 7 the determining includes thresholding the obstacle variable (step 305).

The server handles obstacles that can last for short time, once an obstacle removed from the road the obstacle must also be removed from the obstacle list in the server. Sometime false obstacles are reported to the server by a car and the server need to filter them and not to include it in the obstacle list.

For example—there may be provided a process that may handle removed or false obstacle by using reliability index r as follows; once a car approaches an obstacle location and do not report for an obstacle we reduce the reliability index by a, once the reliability index r is below threshold the obstacle is removed from the list. Hence if an obstacle is removed from the road, the new cars will not detect it and r will be decreased to a value that the obstacle will be removed from the list. In case of a false obstacle is detected by some car we assume that the other cars will not detect it and its reliability index will decrease to a value that it will be removed from the list.

Referring to FIG. 7 that illustrates method 300. Car location is compared to obstacle location, if the car approaches the location, we check in 302, if the car reports of an obstacle, if obstacle is reported, the reliability index r is increased by b in 303. If no obstacle is reported the reliability index r is reduced by a in 304. Note that variable a and b not necessary have the same value. In 305 when r is below a threshold Th, we remove the obstacle from the obstacle list. Otherwise the reliability index r of this obstacle is saved for next car approaching the obstacle.

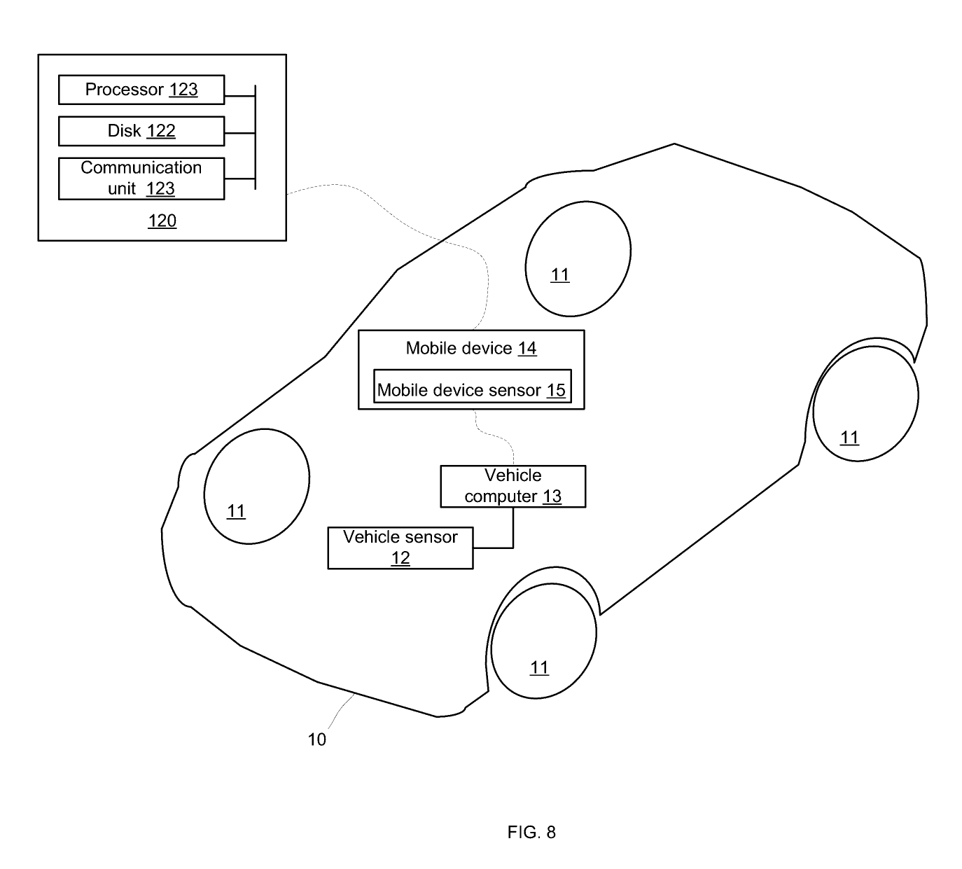

FIG. 8 illustrates a first system that is located, at least partially, within a vehicle 10 and a second system 120 that is located outside the vehicle according to an embodiment of the invention. The vehicle 10 includes many components out of which wheels 11 are shown.

The first system includes a vehicle sensor 12 that is coupled to a vehicle computer 13. The vehicle computer 13 may communicate information sensed by the vehicle sensor 12 to mobile device 14. Mobile device 14 may be a smart phone. The mobile device 14 includes mobile device sensor 15. Mobile device 14 communicates with second system 120 that includes processor 123 a storage unit such as disk 122 and a communication unit 123. The vehicle sensor 12 may be integrated within vehicle 10 or may be detachably attached to vehicle 10.

Obstacle detection may be based on information provided from mobile device sensor 15 and/or vehicle sensor 12. The processing of the detection signals of any of said sensors may be executed by vehicle computer 13, mobile device 14, second system 120 or a combination thereof.

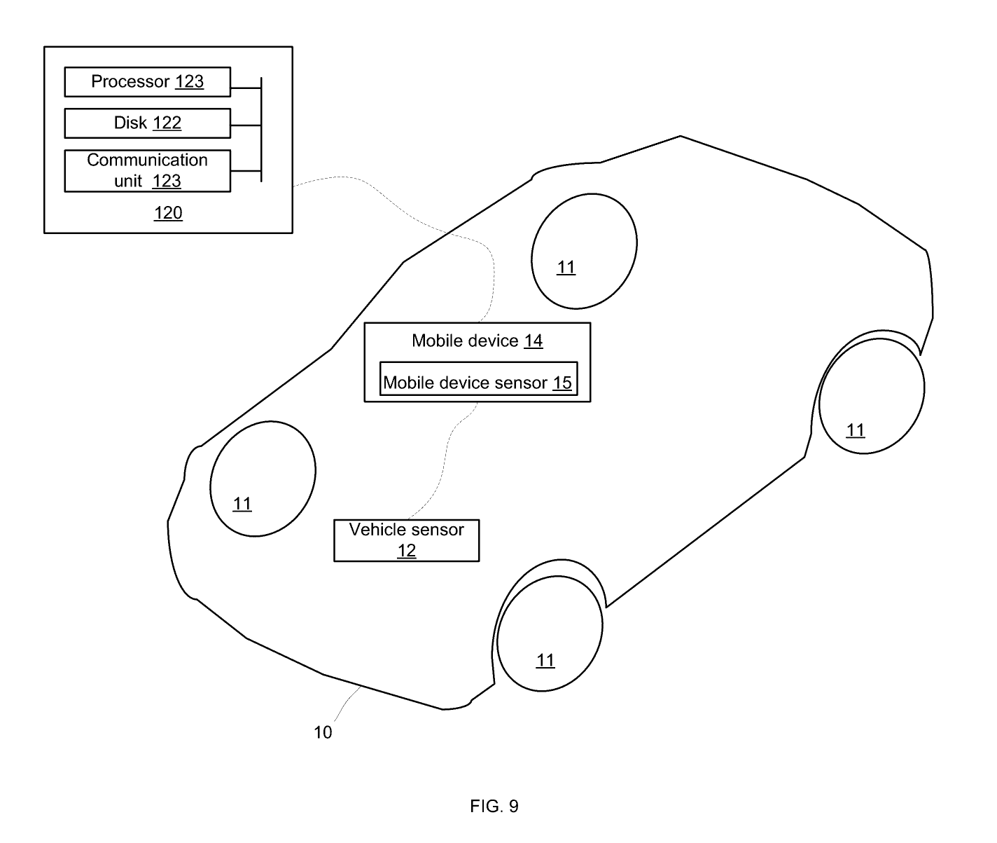

In FIG. 9 the vehicle sensor 12 send detection signals to mobile device 14.

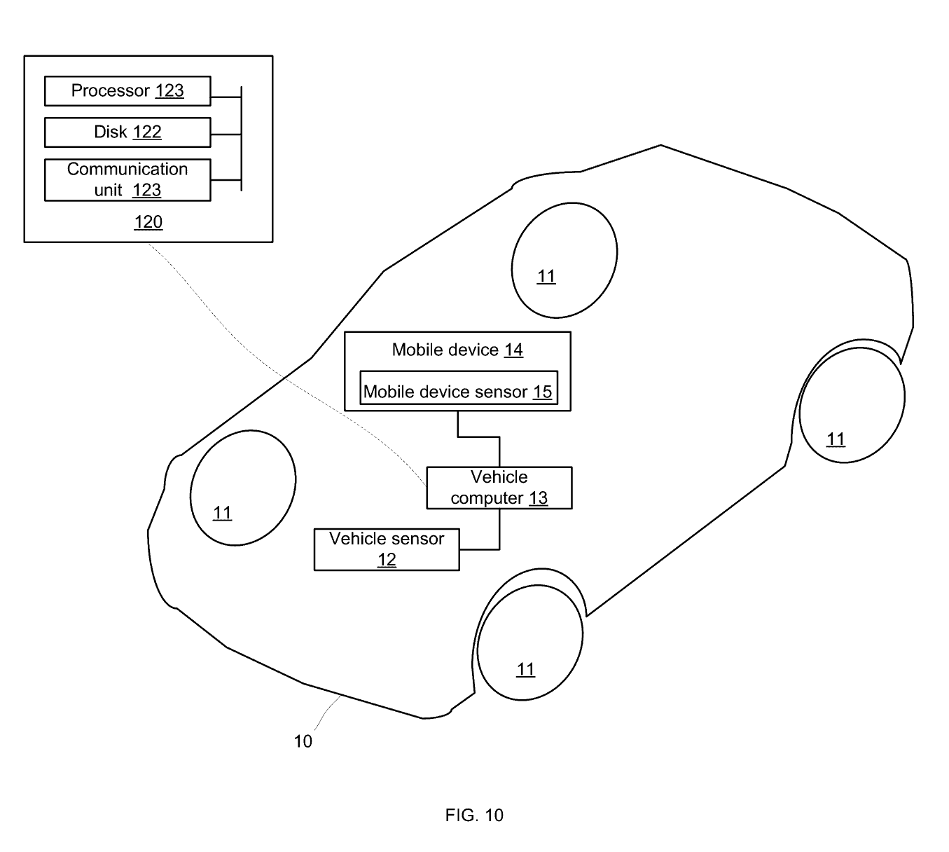

In FIG. 10 the vehicle computer 13 communicates with the second system 120.

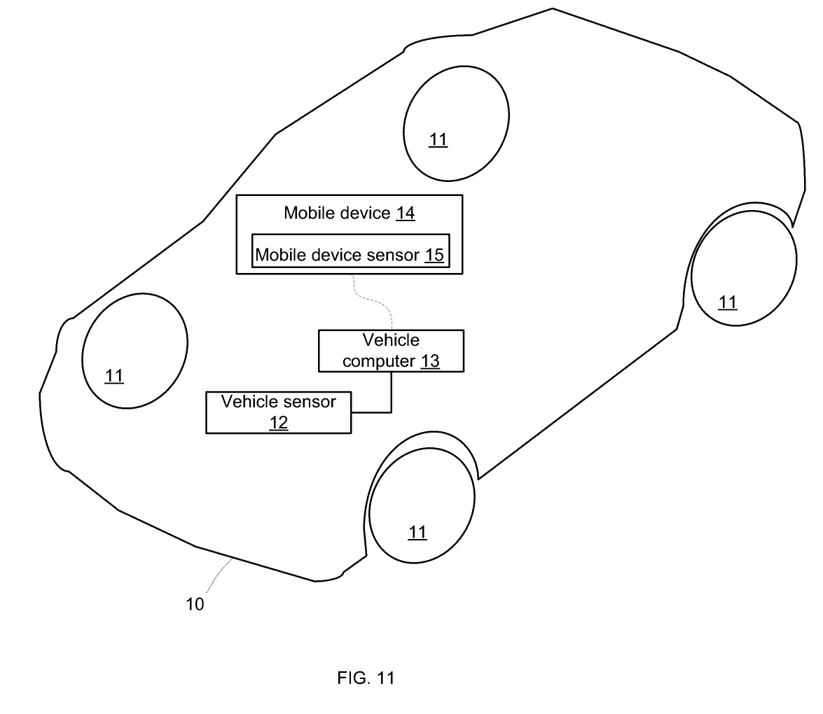

In FIG. 11 the vehicle computer 13 operates as the second system.

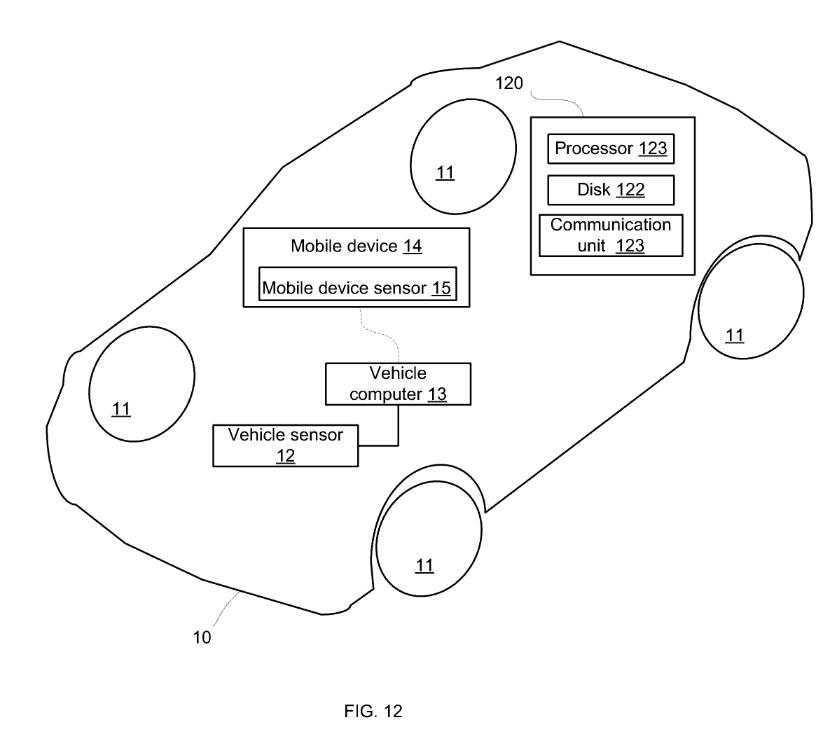

In FIG. 12 the second system 120 is located within vehicle 10.

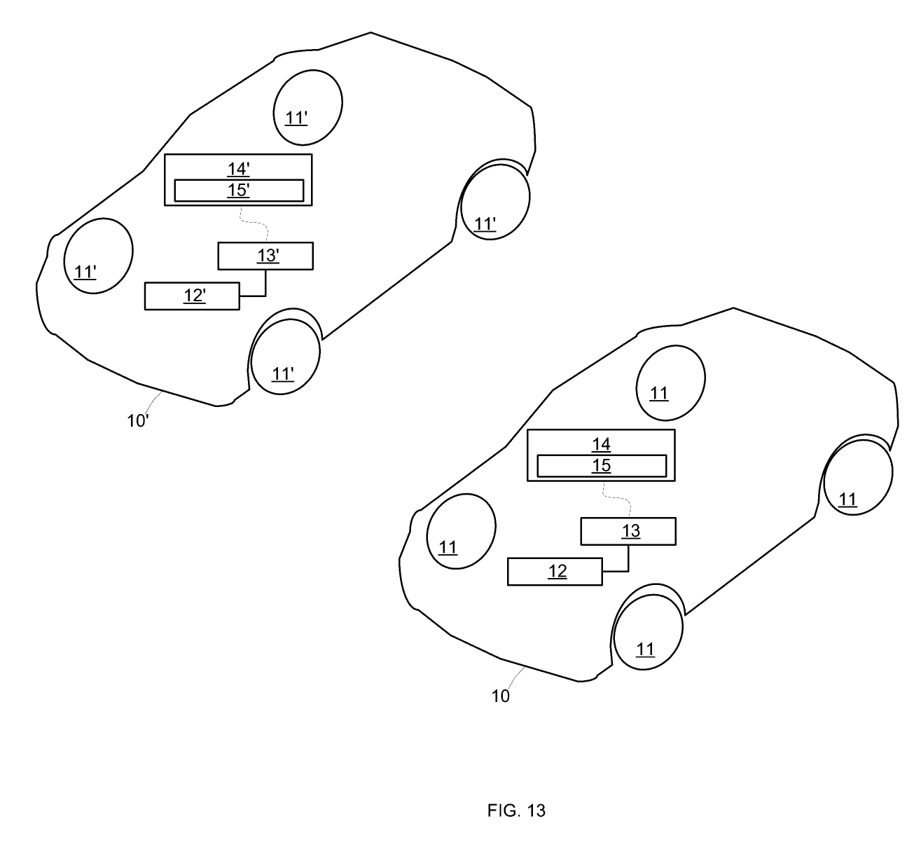

FIG. 13 illustrates vehicle 10 that includes vehicle sensor 12, vehicle computer 12 and a mobile device 14 that include mobile device sensors 15. FIG. 13 also illustrates another vehicle 10′ that includes vehicle sensor 12′, vehicle computer 12′ and a mobile device 14′ that include mobile device sensors 15′. The systems and/or devices within the vehicles may communicate with each other and may provide a distributed second system.

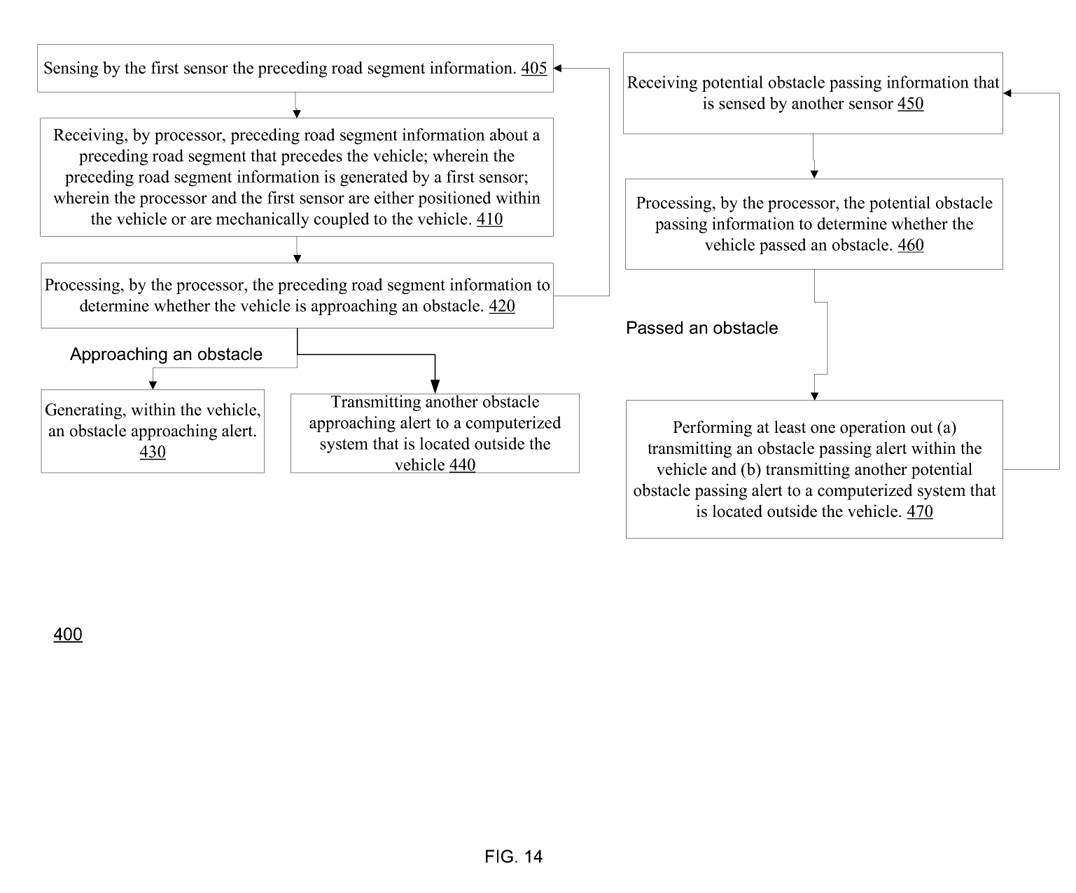

FIG. 14 illustrates a method 400 according to an embodiment of the invention.

Method 400 may be for obstacle detection.

Method 400 may include step 410 of receiving, by processor, preceding road segment information about a preceding road segment that precedes the vehicle; wherein the preceding road segment information is generated by a first sensor; wherein the processor and the first sensor are either positioned within the vehicle or are mechanically coupled to the vehicle

Step 410 may be followed by step 420 of processing, by the processor, the preceding road segment information to determine whether the vehicle is approaching an obstacle.

When determining that the vehicle is approaching the obstacle then step 420 may be followed by step 430 of generating, within the vehicle, an obstacle approaching alert.

Method 400 may also include step 440 of transmitting another obstacle approaching alert to a computerized system that is located outside the vehicle—when determining that the vehicle is approaching the obstacle.

The first sensor may belong to a mobile computerized device (such as but not limited to a smart phone) and the processor may belong to the mobile computerized device. See—for example AP 105, accelerometer 104 and camera 106 of FIG. 1.

The first sensor may be integrated within the vehicle (see for example vehicle sensor 12 of FIG. 8). Method 400 may include receiving additional preceding road segment information from a second sensor that belongs to a mobile computerized device (see, for example mobile device sensor 15 of FIG. 8).

The preceding road segment information of step 410 may differ from preceding obstacle location information. For example—the preceding road segment information may include images of the road that precedes the vehicle, radar or any other sensed information about the road that preceded the vehicle.

Step 410 may be preceded by step 405 of sensing by the first sensor the preceding road segment information.

Method 400 and especially steps 410, 420 and 430 may be executed without human intervention. The driver may trigger the execution of method 400 (for example by opening an application hosted on the mobile device 14).

Method 400 may include step 450 of receiving potential obstacle passing information that is sensed by another sensor (for example accelerometer detection signals).

Step 450 may be followed by step 460 of processing, by the processor, the potential obstacle passing information to determine whether the vehicle passed an obstacle.

Step 460 may be followed by step 470 of performing at least one operation out (a) transmitting an obstacle passing alert within the vehicle and (b) transmitting another potential obstacle passing alert to a computerized system that is located outside the vehicle.

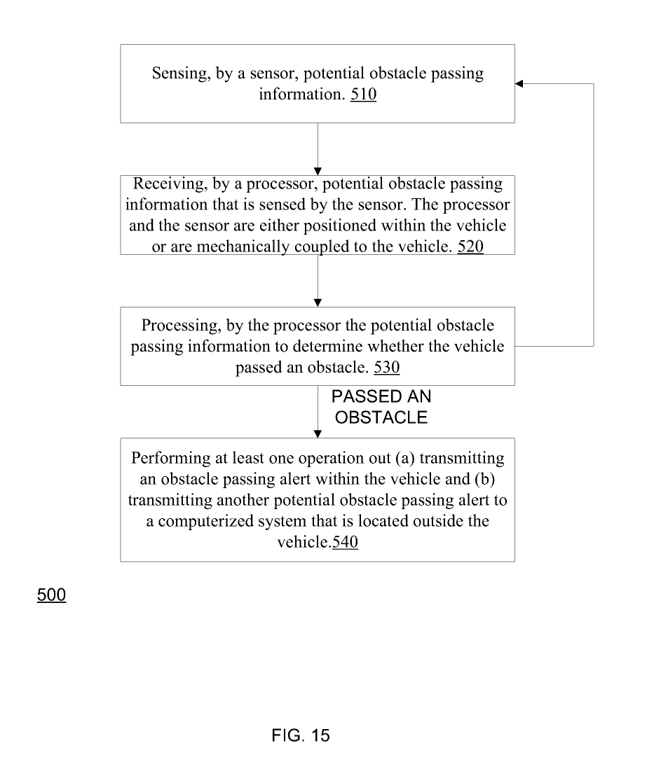

FIG. 15 illustrates method 500 according to an embodiment of the invention.

Method 500 may be for obstacle detection and may start by step 510 or step 520.

Step 510 includes sensing, by a sensor, potential obstacle passing information.

Step 520 includes receiving, by a processor, potential obstacle passing information that is sensed by the sensor. The processor and the sensor are either positioned within the vehicle or are mechanically coupled to the vehicle.

Step 520 may be followed by step 530 of processing, by the processor the potential obstacle passing information to determine whether the vehicle passed an obstacle.

When determining that the vehicle passed the obstacle then step 530 may be followed by step 540 of performing at least one operation out (a) transmitting an obstacle passing alert within the vehicle and (b) transmitting another potential obstacle passing alert to a computerized system that is located outside the vehicle.

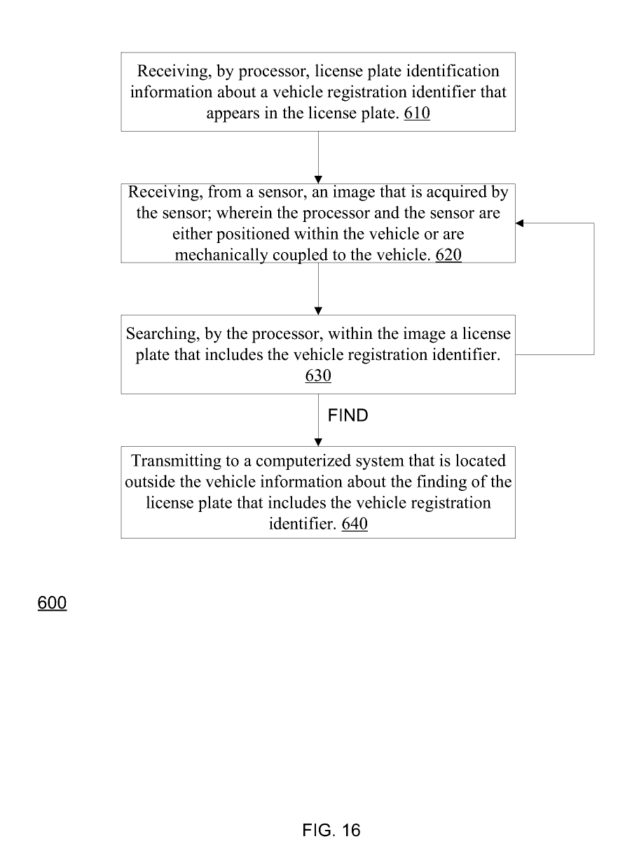

FIG. 16 illustrates method 600 according to an embodiment of the invention.

Method 600 may be a method for detecting a license plate attached to a vehicle, the method may include steps 610, 620, 630, 640 and 650.

Step 610 may include receiving, by processor, license plate identification information about a vehicle registration identifier that appears in the license plate.

Step 610 may be followed by step 620 of receiving, from a sensor, an image that is acquired by the sensor; wherein the processor and the sensor are either positioned within the vehicle or are mechanically coupled to the vehicle.

Step 620 may be followed by step 630 of searching, by the processor, within the image a license plate that includes the vehicle registration identifier.

When finding within the image the license plate that includes the vehicle registration identifier then step 630 may be followed by step 640 of transmitting to a computerized system that is located outside the vehicle information about the finding of the license plate that includes the vehicle registration identifier.

Any combination of any step of any method illustrated above may be provided.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method—respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removable or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for obstacle detection, the method comprising:
receiving, by processor, preceding road segment information about a preceding road segment that precedes the vehicle; wherein the preceding road segment information is generated by a first sensor; wherein the processor and the first sensor are either positioned within the vehicle or are mechanically coupled to the vehicle;
processing, by the processor, the preceding road segment information to determine whether the vehicle is approaching an obstacle; and
when determining that the vehicle is approaching the obstacle then generating, within the vehicle, an obstacle approaching alert.

2. The method according to claim 1 further comprising transmitting another obstacle approaching alert to a computerized system that is located outside the vehicle.

3. The method according to claim 1 wherein the first sensor belongs to a mobile computerized device and wherein the processor belongs to the mobile computerized device.

4. The method according to claim 1 wherein the first sensor is integrated within the vehicle; wherein the method comprises receiving additional preceding road segment information from a second sensor that belongs to a mobile computerized device.

5. The method according to claim 4 wherein the first sensor is a camera.

6. The method according to claim 1 wherein the preceding road segment information differs from preceding obstacle location information.

7. The method according to claim 1 comprising sensing by the first sensor the preceding road segment information.

8. The method according to claim 1 wherein the sensing and the processing are executed without human intervention.

9. The method according to claim 1 comprising receiving potential obstacle passing information that is sensed by another sensor; and processing, by the processor, the potential obstacle passing information to determine whether the vehicle passed an obstacle; and performing at least one operation out (a) transmitting an obstacle passing alert within the vehicle and (b) transmitting another potential obstacle passing alert to a computerized system that is located outside the vehicle.

10. A method for obstacle detection, the method comprising: receiving, by a processor, potential obstacle passing information that is sensed by a sensor; wherein the processor and the sensor are either positioned within the vehicle or are mechanically coupled to the vehicle; processing, by the processor the potential obstacle passing information to determine whether the vehicle passed an obstacle; and when determining that the vehicle passed the obstacle then performing at least one operation out (a) transmitting an obstacle passing alert within the vehicle and (b) transmitting another potential obstacle passing alert to a computerized system that is located outside the vehicle.

11. A method for detecting a license plate attached to a vehicle, the method comprising:
receiving, by processor, license plate identification information about a vehicle registration identifier that appears in the license plate;
receiving, from a sensor, an image that is acquired by the sensor; wherein the processor and the sensor are either positioned within the vehicle or are mechanically coupled to the vehicle;
searching, by the processor, within the image a license plate that includes the vehicle registration identifier; and
when finding within the image the license plate that includes the vehicle registration identifier then transmitting to a computerized system that is located outside the vehicle information about the finding of the license plate that includes the vehicle registration identifier.

12. An obstacle detection system for detecting an obstacle, the system comprises a processor and a first sensor that are either positioned within the vehicle or are mechanically coupled to the vehicle; wherein the processor is configured to receive preceding road segment information about a preceding road segment that precedes the vehicle; wherein the preceding road segment information is generated by the sensor; wherein the processor is configured to process the preceding road segment information to determine whether the vehicle is approaching an obstacle; and wherein the obstacle detection system is configured to generate, within the vehicle, an obstacle approaching alert when the processor determines that the vehicle is approaching the obstacle.

13. An obstacle evaluation system, the obstacle evaluation system comprises a communication unit and a processor and a storage unit;
wherein the communication unit is configured to receive, from multiple vehicles, potential obstacle passing information about potential obstacles that are passed by the multiple vehicle; wherein the potential obstacle passing information is generated by processors based on information sensed by sensors; wherein each processor and each sensor is either located within any of the multiple vehicles or is mechanically coupled to any of the multiple vehicles;
wherein the processor is configured to evaluate a presence a certain obstacle that is positioned at a certain location based on at least one of (a) potential obstacle passing information associated with the certain location, and (b) an absence of potential obstacle passing information associated with the certain location; and
when the communication unit is configured to notify the multiple vehicles about the evaluation of the presence of the certain obstacle.

14. The obstacle evaluation system according to claim 12 wherein the communication unit is configured to receive location information about locations of the multiple vehicles and to notify a vehicle of the multiple vehicles about the certain obstacle when it is evaluated that the certain obstacle is located at the certain position and when the vehicle is located within either one of a predefined distance from the certain obstacle or when the vehicle is within a predefined time period from reaching the certain obstacle.

15. A method for managing obstacle information that method comprises receiving from multiple vehicles information about a presence of obstacle at a given location or about an absence of the obstacle at the given location; determining, based on the information whether the obstacle exists in the given location; and updating, based on the determining, the multiple vehicles about the absence or presence of the obstacle at the given location.

16. The method according to claim 15 where the determining comprising assigning a first weight to information about the presence of the obstacle at the given location; assigning a second weight to information about the absence of the obstacle at the given location; calculating an obstacle variable based on the information provided by the multiple vehicles and to the first and second weights; and determining whether the obstacle exists in the given location based on the obstacle variable.

17. A method for obstacle detection, the method comprising: receiving, by a processor, potential obstacle passing information that is sensed by a sensor; wherein the processor and the sensor are either positioned within the vehicle or are mechanically coupled to the vehicle; processing, by the processor the potential obstacle passing information to determine whether the vehicle passed an obstacle; and when determining that the vehicle passed the obstacle then performing at least one operation out (a) transmitting an obstacle passing alert within the vehicle and (b) transmitting another potential obstacle passing alert to a computerized system that is located outside the vehicle.
